(19) United States
(12) Patent Application Publication
(10) Pub. No.: US 2006/0098983 A1
(43) Pub. Date: May 11, 2006

(54) Optical add/drop multiplexer

(76) Inventors: Jin Soo Han, Daejeon (KR); Heuk Park, Daejeon (KR); Kwang Joon Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/077,111

(22) Filed: Mar. 9, 2005

(30) Foreign Application Priority Data
Nov. 5, 2004 (KR) 10-2004-0090033

(51) Int. Cl. H04J 14/02

(52) U.S. Cl. 398/83

(57) ABSTRACT

The optical add/drop multiplexer of the present invention includes an optical splitting means dividing a wavelength division multiplexed optical signal into a pass path and a drop path; a first wavelength selection switching means receiving the dropped optical signal, demultiplexing the received optical signal, and switching a specific wavelength to one drop port; a channel equalizing means blocking the dropped optical signal, and passing a signal of remaining. wavelengths therethrough while causing the intensity thereof to be uniform; a second wavelength selection switching means receiving a plurality of optical signals through respective input ports, demultiplexing the received optical signals, and switching a specific wavelength to one add port; and an optical coupling means recombining an optical signal passed through the channel equalizing means and the optical signal output from the second wavelength selection switch.

### BACKGROUND OF THE INVENTION

1. Field of the Invention

The present invention relates generally to an optical add/drop multiplexer and, more particularly, to an optical add/drop multiplexer, in which an optical splitter and an optical coupler are respectively connected to the front and rear ends of a channel equalizer through wavelength selection switches, thus enabling the adding/dropping of arbitrary wavelengths through arbitrary add/drop ports on the nodes of a wavelength division multiplexing optical transmission system.

2. Description of the Prior Art

Currently, a Wavelength Division Multiplexing (WDM)-based optical transmission network technology is one of research fields that attract attention all over the world. Such a WDM-based optical transmission network necessarily requires an apparatus having a function of enabling the adding/dropping of each channel (wavelength) on an arbitrary subscriber node.

An Optical Add/Drop Multiplexer (OADM) allows intermediate nodes, which exist on a transmission path, to be linked on a wavelength basis, thus being capable of expanding the connectivity of a network and increasing the efficiency thereof. A fixed type OADM is disadvantageous in that maintenance and repair costs are high because manual work is required when a network is reconstructed. However, an OADM that can remotely reconstruct a network can overcome the disadvantage of the fixed type OADM, and allows adding/dropping on the nodes to be reconstructed at a remote place, and allows the wavelength assignment of the network to be efficiently reconstructed, thus flexibly coping with variation in traffic conditions. Accordingly, the maintenance and repair costs of the network can be reduced.

FIG. 1 is a schematic diagram showing the construction of a conventional OADM. As shown in FIG. 1, in the conventional OADM, a wavelength division multiplexed optical signal is input to a first optical splitter 10 through an input path 11. The first optical splitter 10 divides the input optical signal into a drop path 12 and a first through path 13. The optical signal that is transmitted to the drop path 12 is input to a second optical splitter 20. The second optical splitter 20 drops the optical signal in a wavelength division multiplexed state, and individual wavelengths are selected by a plurality of wavelength tunable filters 60 on the output ports of the second optical splitter 20. That is, an arbitrary output port receives all the wavelengths of an optical signal and then selects a desired wavelength from the optical signal. Consequently, a desired wavelength can be output through a desired port.

Meanwhile, the optical signal transmitted to the first through path 13 is input to a Dynamic Channel Equalizer (DCE) 30. The DCE 30, as shown in FIG. 2, includes a demultiplexer 31, a Variable Optical Attenuator (VOA) 32 and a multiplexer 33. Since the DCE 30 may be easily implemented by those skilled in the art, a detailed description of the DCE 30 is omitted. The DCE 30 makes optical intensity uniform while blocking the wavelength of the dropped optical signal and passing the other wavelengths through a second through path 14. The optical signal output from the DCE 30 is input to an optical combiner 40, and the optical combiner 40 adds the optical signal on the second through path 14 and an optical signal on an add path 15 and outputs a resulting optical signal through an output path 16. In this case, a second optical combiner 50 outputs external optical signals to the add path 15 in a wavelength division demultiplexed state.

However, since the conventional OADM employs the optical splitter/combiner having multiple ports, the conventional OADM has disadvantages in that high insertion loss occurs in add/drop ports and a wavelength tunable filter is required for each port. For example, although 1×8 optical splitter/coupler theoretically have an insertion loss of about 9 dB, 1×8 optical splitter/combiner have a practical insertion loss of about 10 dB when implemented. Furthermore, when 1×16 optical splitter/combiner are used for a high number of ports, they have an insertion loss of about 13 dB. Furthermore, an insertion loss of 0.5-1 dB additionally occurs due to the wavelength tunable filters.

Another conventional OADM is disclosed in Korean Pat No. 400362 issued on Sep. 22, 2003, in which a predetermined group of wavelengths is assigned and an increase in wavelength is easily made so that a demultiplexer, a multiplexer, a channel selector and a channel coupler are not additionally required when wavelengths increase. Furthermore, still another conventional OADM is disclosed in U.S. Pat No. 6,233,074 B1, in which the conventional OADM is capable of dropping or adding desired wavelengths, optical splitters are placed behind a demultiplexer and in the front of a multiplexer to add/drop the wavelengths, respectively, and add/drop ports are fixed to specific wavelengths.

Another OADM capable of increasing a transmission distance by reducing the insertion loss of a through path is disclosed in an OADM-related paper “Transparent ultra-long haul DWDM networks with ‘broadcast-and-select’ OADM/OXC architecture,” Journal of lightwave technology, Vol. 21, No. 11, pp. 2661, November 2003, by Michael Vasiyev, Ioannis Tomkos, et al. However, the apparatus disclosed in the paper can assign arbitrary wavelengths to add/drop ports, but cannot reduce the insertion loss of the add/drop paths.

Another OADM, which constructs a node using a channel equalizer and monitors faults by monitoring a wavelength selection switch and the optical intensity of each wavelength with respect to a dropped signal, is disclosed in another paper “A broadcast and select OADM optical network with dedicated optical-channel protection,” Journal of lightwave technology, Vol, 21, No. 1, pp. 25, January 2003, by June-koo Rhee, Ioannis Tomkos and Ming-jin Li. However, this apparatus was proposed to protect a ring by detecting the optical intensity of each finally demultiplexed wavelength.

### SUMMARY OF THE INVENTION

The present invention provides an OADM, which is capable of reducing insertion loss on add/drop paths and, which is capable of adding/dropping arbitrary wavelengths to add/drop ports using a channel equalizer and wavelength selection switches.

The present invention provides an optical add/drop multiplexer, including an optical splitting means for dividing a wavelength division multiplexed optical signal into a through path and a drop path; a first wavelength selection switching means for receiving the optical signal that is dropped to the drop path, demultiplexing the received optical signal on a wavelength basis, and then switching a specific wavelength to one drop port selected from among a plurality of output ports; a channel equalizing means for blocking the optical signal of the specific wavelengths that is dropped to the drop path, and passing a signal of remaining wavelengths therethrough while making the intensity thereof uniform; a second wavelength selection switching means for receiving a plurality of optical signals, which are to be added, through respective input ports, demultiplexing the received optical signals on a wavelength basis, and then switching a specific wavelength, which is received through one input port selected from among a plurality of input ports, to one add port; and an optical combining means for recombining an optical signal that is passed through the channel equalizing means and the optical signal that is output from the second wavelength selection switch.

According to an embodiment of the present invention, the first wavelength selection switching means includes a 1×N demultiplexer for demultiplexing the optical signal dropped to the drop path on a wavelength basis; N 1×K switches for receiving the demultiplexed optical signals through input ports, and switching an optical signal of a specific wavelength to each drop port selected from among a plurality of drop ports; and K N×1 multiplexers for receiving optical signal sets, which are output from each of the N 1×K switches, through input port sets, and multiplexing and outputting the received optical signals.

In addition, according to an embodiment of the present invention, the second wavelength selection switching means includes K 1×N demultiplexers for receiving optical signals to be added through the input ports, and demutliplexing each of the received optical signals; N K×1 switches for receiving N optical signals, which are output from the K 1×N demultiplexers, through input ports, and switching an optical signal of a specific wavelength to each output port; and an N×1 multiplexer for receiving and multiplexing N optical signals output from the N K×1 switches.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing the construction of the conventional OADM;

FIG. 2 is a diagram showing a DCE that is applied to the conventional OADM;

FIG. 3 is a schematic diagram showing the construction of an OADM according to an embodiment of the present invention; and

FIG. 4 is a diagram showing the internal construction of a wavelength selection switch that is applied to an OADM according to the embodiment of the present invention.

### DESCRIPTION OF THE PREFERRED EMBODIMENTS

A preferred embodiment of the present invention is described in detail with reference to the accompanying drawings below. When the present invention is described below, unnecessary detailed descriptions will be omitted if the detailed descriptions of well-known functions or constructions related to the present invention make the gist of the present invention unclear.

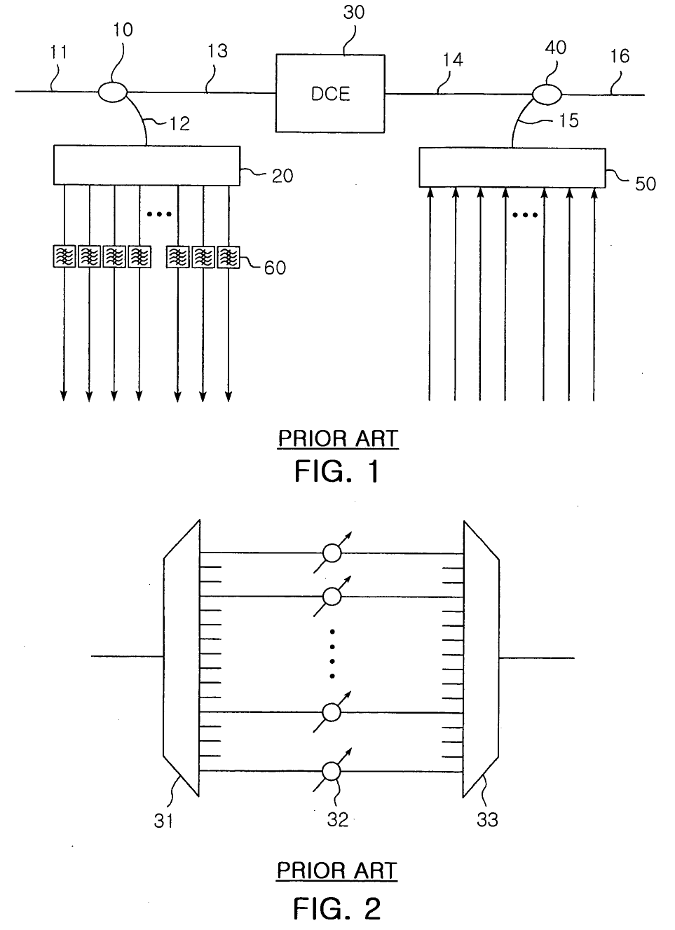

Furthermore, when an OADM according to the present invention is described, elements of the conventional OADM, which are shown in FIGS. 1 and 2, identical to the elements applied to the present invention may be used without change for ease of description.

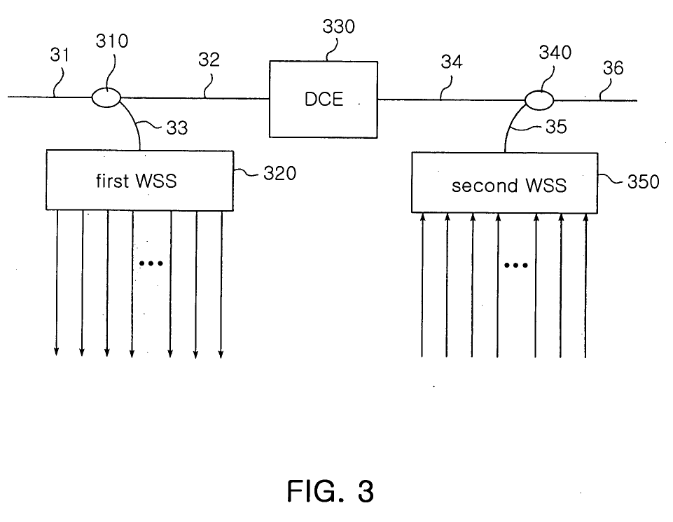

FIG. 3 is a schematic diagram showing the construction of an OADM according to an embodiment of the present invention. It should be, noted that the OADM 300 shown in FIG. 3 is only a preferred embodiment for describing the present invention, and may be changed, replaced and modified within a range that does not depart from the technical spirit of the invention. As shown in FIG. 3, the OADM 300 according to the embodiment of the present invention includes an optical splitter 310 for dividing a wavelength division multiplexed optical signal, which is input through an input path 31, into a first through path 32 and a drop path 33, a first Wavelength Selection Switch (WSS) 320 for receiving an optical signal, which is dropped to the drop path 33, through an input port, and demultiplexing the received optical signal on a wavelength basis, and then switching a specific wavelength to one drop port that is selected from a plurality of ports, a DCE 330 for blocking an optical signal of wavelengths, which is dropped to the drop path 33, and passing an optical signal of the other wavelengths therethrough while making the intensity thereof uniform, a second WSS 350 for receiving optical signals, which are to be added and are input from the outside, through respective input ports, demultiplexing the optical signals on a wavelength basis, and switching a specific wavelength, which is received through one input port selected from among a plurality of input ports, to one output port, and an optical combiner 340 for recombining the optical signal on the second through path 34 that is output from the DCE 330 and the optical signal that is output from the second WSS 350 and then outputting a resulting optical signal through an output path 36. Preferably, the conventional DCE 30 of FIG. 2 is employed as the DCE 330 of the present invention without change for convenience of implementation. Furthermore, although not shown in the drawings, the first and second WSSs 320 and 350 and the DCE 330 are controlled by an external controlling device.

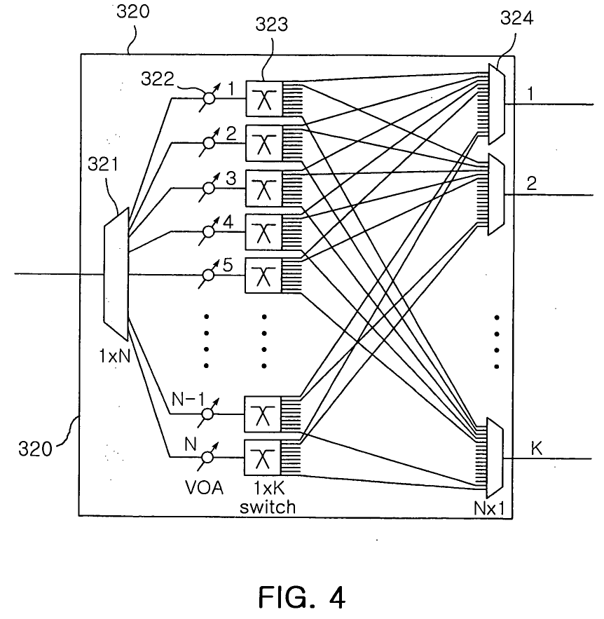

With reference to FIG. 3, the OADM 300 in accordance with a preferred embodiment of the present invention is described in detail. Referring to FIG. 3, a wavelength division multiplexed optical signal, which is input through an input path 31, is divided by the optical splitter 310 and then transmitted to a first through path 32 and a drop path 33. In the preferred embodiment of the present invention, the optical splitter 310 preferably is a 1×2 optical splitter, and divides the input wavelength division multiplexed optical signal usually in a ratio of 50 to 50. The optical signal that is dropped to the drop path 33 is input to the input port of the first WSS 320, and the optical signal that is dropped to the first through path 32 is input to the input port of the DCE 330. The DCE 330 may be constructed as shown in FIG. 2. The DCE 330 blocks the optical signal of wavelengths that is dropped to the drop path 33, and passes the optical signal of the other wavelengths while making the intensity of the optical signal uniform. Meanwhile, of the optical signals that have been input to the input port of the first WSS 320 through the drop path 33, each wavelength signal to be dropped is output to a corresponding output port by operating the first WSS 320. This operation is described in more detail below. In accordance with a preferred embodiment of the present invention, the first WSS 320 includes one input port and a plurality of drop ports, and allows a signal of arbitrary wavelengths to be output through an arbitrary port after receiving the optical signal, which is dropped to the drop path 33, through the input port, and switching a specific wavelength of the received optical signal to one drop port selected from among the plurality of drop ports. As described above, the first WSS 320 of the present invention determines one of the pluralities of drop ports through which a signal of a specific wavelength is output, and allows the signal of the specific wavelength to be switched to any one of a plurality of drop ports. With reference to FIG. 4, the first WSS 320 is described in more detail below.

FIG. 4 is a diagram showing the internal construction of a WSS that is applied to the OADM according to an embodiment of the present invention. As shown in FIG. 4, the first WSS 320 according to the present invention includes a 1×N demultiplexer 321 for receiving the optical signal dropped to the drop path 33 and then demuliplexing the dropped optical signal on a wavelength basis, N 1×K switches 323 for receiving optical signals demultiplexed by the demultiplexer 321 and switching an optical signal of a specific wavelength to one drop port selected from among a plurality of drop ports, and K N×1 multiplexers 324 for receiving optical signals, which are output from each of N 1×K switches 323, and multiplexing and outputting the received optical signals. In another embodiment of the present invention, Variable Optical Attenuators (VOAs) 322 may be included between the 1×N demultiplexer 321 and the 1×K switches 323. The N and K are natural numbers, each of which is equal to or greater than 2.

Referring to FIG. 4, the 1×N demultiplexer 321 receives the optical signal dropped to the drop path 33 and demultiplexes the dropped optical signal to N optical signals on a wavelength basis. The optical signals, which are generated by demultiplexing the optical signal on a wavelength basis, are input to the N 1×K switches 323, respectively, each having one input port and K output ports. Each of the N 1×K switches 323 receives an optical signal through its input port and switches the optical signal of a specific wavelength to an output port that is selected from among a plurality of drop ports. In other words, each of the N 1×K switches 323 switches the optical signal of the specific wavelength demultiplexed by the demultiplexer 321 to one of the first to Kth output port sets. Thereafter, the N×1 multiplexers 324 receive optical signals that are output from the N 1×K switches 323 through the K input port sets, and multiplex and output the received optical signals. That is, optical signals that are output to the first output ports of the 1×K switches 323 are received by the first input port set of the N×1 multiplexers 324, and optical signals that are output to the Kth output ports of the 1×K switches 323 are received by the Kth input port set of the N×1 multiplexers 324. The optical signals received as described above are multiplexed and then output.

Meanwhile, in another embodiment of the present invention described above, when the VOAs 322, which are included between the 1×N demultiplexer 321 and the 1×K switches 323, are used, the intensity of optical signals that are output from the N×1 demultiplexers 321 can be adjusted to fit devices connected to the VOAs 322.

As shown in FIG. 4, the first WSS 320 according to the present invention has a total insertion loss below 8 dB because the insertion losses of the 1×N demultiplexer 321, VOAs 322, the 1×K switches 323, and the N×1 multiplexers 324 are approximately 3 dB, 0.5˜1 dB, 1 dB and 3 dB, respectively. Furthermore, although the number of drop ports increases in the structure of the first WSS 320, constant insertion loss is maintained. Accordingly, the present invention can considerably reduce insertion loss compared to the case of using the conventional optical splitter/combiner shown in FIG. 1. The higher the number of ports is, the greater the difference of the insertion loss. This is the same as in the second WSS 350 described below.

Referring to FIG. 3 again, the optical signals that are output from the DCE 330 to the second through path 34 are input to the optical combiner 340. The optical combiner 340 adds the optical signals on the second through path 34 and the add path 35 and outputs a resulting signal to the output path 36. The optical signal on the add path 35 is an optical signal selected by the second WSS 350. That is, the second WSS 350 receives optical signals, which are to added and are transmitted from the outside, through the input ports, and demultiplex the optical signals received through the input ports on a wavelength basis, and switches a specific wavelength, which is received through one input port selected from among plurality of input ports, to one add port so that the specific wavelength is combined to the add path 35. The internal construction of the second WSS 350 is the reverse of that of the first WSS 320, and the elements of the second WSS 350 perform the same operation as those of the first WSS 320.

That is, although not shown in the drawings, the input port of the first WSS 320 corresponds to the add port of the second WSS 350, and the drop ports of the first WSS 320 correspond to the input ports of the second WSS 350. Accordingly, the second WSS 350 receives K optical signals, which are input from the outside, through the K input port, processes the optical signals in the reverse order to that of the first WSS 320 and then outputs a resulting signal to one add port, thus allowing arbitrary wavelengths to be assigned to the add port. In this case, it should be noted that the 1×N demultiplexer 321 and N×1 multiplexers 324 of the first WSS 320 operate similarly to the N×1 multiplexer and 1×N demultiplexers of the second WSS 350, respectively. Accordingly, the 1×K switches 323 of the first WSS 320 operates similarly to the K×1 switches of the second WSS 350.

In the second WSS 350 constructed as described above, a specific wavelength of the optical signals, which are input from the outside, can be assigned to an arbitrary add port. The optical signal output from the second WSS 350 is input to the optical combiner 340 through the add path 35, and the optical combiner 340, as described above, recombines the optical signals on the second through path 34 and paths 35 and then transmits a resulting signal through the output path 36 to the next node, as described above.

As described above, the present invention employs the WSSs on the add/drop paths in a structure in which the DCE is used, so that insertion loss can be reduced compared to the structure in which the 1×N optical splitter is used, and an implementation cost is low because it is unnecessary to use wavelength tunable filters.

The above-described detailed description and drawings above describe the technical spirit regarding the OADM according to the present invention, and are not intended to limit the present invention but illustrate the most preferred embodiments of the invention. In particular, although it is described that the WSS as shown in the drawing is used in the embodiment of the present invention, and other switches that allow arbitrary wavelengths to be dropped and added to arbitrary add/drop ports may also be employed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical add/drop multiplexer, comprising:
optical splitting means for dividing a wavelength division multiplexed optical signal into a through path and a drop path;
first wavelength selection switching means for receiving the optical signal that is dropped to the drop path, demultiplexing the received optical signal on a wavelength basis, and then switching a specific wavelength to each drop port selected from among a plurality of output ports;
channel equalizing means for blocking the optical signal of the specific wavelength that is dropped to the drop path, and passing a signal of remaining wavelengths therethrough while making the intensity thereof uniform;
second wavelength selection switching means for receiving a plurality of optical signals, which are to be added, through respective input ports, demultiplexing the received optical signals on a wavelength basis, and then switching a specific wavelength, which is received through one input port selected from among a plurality of input ports, to one add port; and
optical combining means for recombining an optical signal that is passed through the channel equalizing means and the optical signal that is output from the second wavelength selection switch.

2. The optical add/drop multiplexer according to claim 1, wherein the first wavelength selection switching means comprises:
a 1×N demultiplexer for demultiplexing the optical signal dropped to the drop path on a wavelength basis;
N 1×K switches for receiving the demultiplexed optical signals through input ports, and switching an optical signal of a specific wavelength to each drop port selected from among a plurality of drop ports; and
K N×1 multiplexers for receiving optical signals, which are output from each of the 1×K switches, and multiplexing and outputting the received optical signals.

3. The optical add/drop multiplexer according to claim 2, wherein the first wavelength selection means further comprises variable optical attenuators that are placed between the 1×N demultiplexer and the 1×K switches and adjust intensity of the optical signals that are output from the 1×N demultiplexer.

4. The optical add/drop multiplexer according to claim 1, wherein the second wavelength selection switching means comprises:
K 1×N demultiplexers for receiving optical signals to be added through the input ports, and demultiplexing each of the received optical signals;
N K×1 switches for receiving optical signals, which are output from the K 1×N demultiplexers, and switching an optical signal of a specific wavelength to each output port; and
an N×1 multiplexer for receiving and multiplexing N optical signals output from the K×1 switches.

5. The optical add/drop multiplexer according to claim 4, wherein the second wavelength selection means further comprises variable optical attenuators that are placed between the K×1 switches and the N×1 multiplexer and adjust intensity of the optical signals that are output from the switches.
